(19) United States
(12) Patent Application Publication
(10) Pub. No.: US 2010/0071522 A1
(43) Pub. Date: Mar. 25, 2010

(54) Universal Rotary Blade for Fabric Embellishment

(76) Inventor: Pattie Otto, Racine, WI (US)

Correspondence Address: ABSOLUTE TECHNOLOGY LAW GROUP LLC, 135 W. WELLS ST., SUITE 518, MILWAUKEE, WI, 53203, US

(21) Appl. No.: 12/235,280

(22) Filed: Sep. 22, 2008

(51) Int. Cl. B23D 25/12; B23D 19/00

(52) U.S. Cl. 83/343; 83/174.1

(57) ABSTRACT

A rotary blade for an interchangeable rotary cutter comprising perfectly spaced teeth. The rotary cutter and blade are passed over wearable fabric creating perfectly spaced slits in the fabric which are spaced far enough apart so that the fabric will not tear when pulled. The user can hand stitch ribbon, cord, heavy thread, yarn or other embellishment through the slits creating a decorative edge. The size and shape of the slits allows the user to hand stitch without having to tug on the needle. Slits created in multiple pieces of fabric allow the user to seam the pieces together using ribbon, cord, heavy thread, yarn or other embellishment creating a decorative seam.

### FIELD OF INVENTION

This invention relates generally to the field of rotary blades, and in particular to a rotary blade for piercing wearable fabric.

### BRIEF DESCRIPTION OF DRAWINGS

FIG. 1 shows an embodiment of a rotary blade for fabric embellishment which may be inserted in any rotary cutting device.

FIG. 2a shows a rotary cutting tool with multiple blades

FIG. 2b shows a rotary cutting tool with a housing.

FIG. 3 shows a rotary cutting tool with an edge guide.

FIG. 4 shows a rotary cutting tool with an edge guide that is a light.

### BACKGROUND

It is known in the prior use to use rotary cutters for paper (such as in scrapbooking), and in the art of trimming fabric to the desired dimensions. A rotary cutter is generally a round blade on an axle which is inserted in or attached to a handle so the blade can be rotated over the fabric or paper. Some blades have teeth to make slits or perforation marks in fabric, which are regularly spaced, segmented cuts, or which may be scalloped or in decorative patterns.

An example of a rotary cutter with a perforating rotary blades known in the prior art is “Rotary Perforating Blade” sold by Fiskars Madison Wis. is example of a perforating rotary blade.

However, rotary cutters with teeth (e.g., perforated rotary blades) which currently exist in the prior art, while effective for scrapbooking and crafts using paper, are ineffective on fabric because they cause the fabric to tear, shred or unravel.

Commercially available perforated rotary blades for hand-held devices are not recommended for cutting holes or slits in fabric for hand stitching or seaming. The fabric is often torn or cut irregularly, and presently manufactures of hand-held rotary cutters have been unable to solve this problem, or design blades and cutting tools which resolve it.

While traditional sewing machines are capable of perforating fabric in a manner which allows for hand stitching, there is no hand held rotary cutting device which effectively perforates fabric in manner which allows for hand stitching or seaming.

It is desirable to have a perforating rotary blade tool which can effectively perforate fabric, and which can be used as an alternative to a sewing machine for this purpose.

Additionally when using a sewing machine to perforate certain fabrics such as leather, faux leather, or suede, a special industrial grade or manufacturing-type sewing machine may be required.

It is desirable to have a perforating rotary blade tool which can effectively perforate fabric, and which can be used as an alternative to a sewing machine for this purpose, and which will not tear, shred, or deform fabric.

It is further desirable to have a special blade for cutting fabric which is interchangeable with blades used in existing 45 mm cutting tools.

### SUMMARY OF THE INVENTION

It has recently been discovered that the reason for tearing, fraying and other problems with fabric when using a rotary cutting blade can be avoided by precision spacing of the teeth on a traditional rotary cutting blade. It is further desirable to have a perforating rotary blade which can be used with standard hand-held rotary cutters such as a Fiskars Rotary Cutter (e.g., any 45 mm rotary cutting handle).

The present invention is a rotary blade with teeth that creates perfectly spaced perforations in the wearable fabric when the rotary blade is passed over the wearable fabric, which may be interchanged with traditional rotary blades in cutting tools without the use of tools. Hand-stitching or seaming with ribbon, yarn, cord or other embellishment is used to create decorative edges or seams. The teeth are spaced such a distance apart that they perforate the wearable fabric in a way that allows for decorative hand stitching or seaming, but which does not cause the wearable fabric to tear when pulled. The rotary blade is available in various sizes designed to fit different sizes of standard rotary cutters.

### GLOSSARY

As used herein, the term “wearable fabric” refers to fabric which can be worn such as outerwear fleece, Berber, Minky, sweatshirt fleece, stretch velvet, felt, knits, leather and other mid to heavyweight non-ravel fabrics. Wearable fabric may be in the form of an article of clothing, such as a sweater or vest, a blanket or any other item (e.g., a Christmas stocking, a tote bag).

As used herein, the term “interchangeable rotary cutter” refers to a device that is designed to receive one or more rotary blades. The interchangeable rotary cutter may be designed to receive a specific size of rotary blade or may be adjustable to receive various sizes of rotary blades. The rotary cutter comprises a handle which may be straight, curved to the fit the palm of the user's hand, contoured to fit the user's fingers or any other shape that provides comfort and ease of use to the user. In some embodiments, the handle is designed ergonomically. The interchangeable rotary cutter may additionally comprise a blade trigger which retracts the blade, a lock button which locks and unlocks the blade or any other feature which increases the comfort or safety of the user.

As used herein, the term “interchangeable rotary handle” refers to a rotary cutter which is designed to receive one or more rotary blades. The interchangeable rotary handle may be of varying sizes, have an ergonomic design and/or contoured grip, a blade trigger which retracts the blade, a lock button which locks and unlocks the blade, or any other feature which increases the comfort or safety of the user, or handles of varying length and weights to provide additional leverage when cutting thick or resilient fabric.

As used herein, the term “teeth” refer to the small sharp points along the cutting edge of the rotary blade.

As used herein, the term “slit or slits” refers to the holes the teeth of the rotary blade create in the wearable fabric when the rotary blade is passed over the fabric.

As used herein, the term “anthropometrically proportioned handle” refers to the handle of a rotary cutter which is ergonomically designed to fit all hand sizes and which reduces fatigue and allows for varied angles and positions. In other embodiments, the anthropometrically proportioned handle is contoured to fit the shape of a hand.

As used herein, the term “edge guide” refers to a protuberance or extension which allows a user to maintain a uniform distance from an edge, hem or other reference point when using the rotary cutting tool.

As used herein, the term “multi-blade” refers to more than one rotary blade attached side-by-side which allow the user to create multiple rows of slits with a single pass of the blades. The distance separating the blades will determine the distance between the slits when the rotary blades are passed over the wearable fabric. In another embodiment, the blades may be off-set from each other resulting in misaligned slits.

As used herein, the term “embellishment” refers to ribbon, cord, heavy thread, textured thread, chenille yarn, metallic yarn, eyelash yarn, fuzzy yarn and other material which may be threaded through the slits created by the teeth of the rotary blade. One or more color or types of embellishments may be used for a single row of slits or on a single piece of wearable fabric.

As used herein, the term “hand stitching” refers to using a needle with a blunt point, a tapestry needle or other similar item to thread a satin ribbon, rattail cord, or other embellishment through the slits created by the disclosed rotary blade. Hand stitches include, but are not limited -to whip stitches, rolled whip stitches, blanket stitches, lattice stitches, rolled lattice stitches or other type of stitch known in the art. In other embodiments, a crochet hook or knitting needle and yarn are used to create a decorative edge.

As used herein, the term “seaming” refers to attaching two pieces of wearable fabric having slits created by the disclosed rotary blade. A seam is created by hand-stitching or crocheting a ribbon, yarn or other embellishment using a whip seam, lattice seam, chevron seam or any other type of seam known in the art as creating a decorative seam. The two pieces of wearable fabric may be flush together or overlapping when seamed.

As used herein, the term “interchangeable” refers to a rotary cutter wherein a rotary blade may be added or removed.

### DETAILED DESCRIPTION OF EMBODIMENTS OF THE INVENTION

For the purpose of promoting an understanding of the present invention, references are made in the text hereof to embodiments of a rotary blade which creates slits in wearable fabric for decorative hand-stitching or sewing, only some of which are described herein. It should be understood, nevertheless, that no limitations on the scope of the invention are thereby intended. One of ordinary skill in the art will readily appreciate that modifications such as the dimensions, size, and shape of the components, alternate but functionally similar locations, and the inclusion of additional elements are deemed readily apparent and obvious to one of ordinary skill in the art; and all equivalent relationships to those illustrated in the drawings and described in the written description do not depart from the spirit and scope of the present invention. Some of these possible modifications are mentioned in the following descriptions. Therefore, specific details disclosed herein are not to be interpreted as limiting, but rather as a representative basis for teaching one of ordinary skill in the art to employ the present invention in virtually any appropriately detailed apparatus or manner.

It should be understood that the drawings are not necessarily to scale, emphasis instead being placed upon illustrating the principles of the invention. In addition, in the embodiments depicted herein, like reference numerals in the various drawings refer to identical or near identical structural elements.

Moreover, the term “substantially” or “approximately” as used herein may be applied to modify any quantitative representation that could permissibly vary without resulting in a change in the basic function to which it is related.

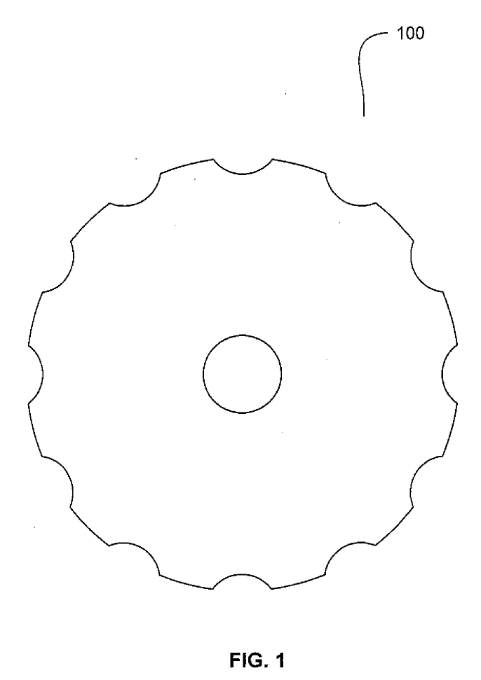

Referring now to the drawings, FIG. 1 shows one embodiment of a rotary blade In the embodiment shown, the rotary blade teeth are spaced ⅜ inch apart and the rotary blade is sized to fit a standard 45 mm rotary cutter. In other embodiments, the distance between the teeth may be less than or greater than ⅜ inch. The rotary blade may also be sized to fit other sizes of rotary cutters, such as 28 mm or 60 mm rotary cutters.

The rotary blade teeth create slits in the wearable fabric when passed over the fabric. The size and shape of the teeth create slits in the wearable fabric which allow decorative ribbon, cord, heavy thread, yarn or other embellishment to easily slip through the slits without tugging or resorting to a pliers to pull a needle through the wearable fabric. The perfectly spaced teeth result in perfectly spaced hand stitches eliminating the need for marking and pre-punching holes with a significant savings of time and effort. The rotary blade allows the user to add decorative edges to a wearable fabric or to attach knit cuffs to hats and mittens.

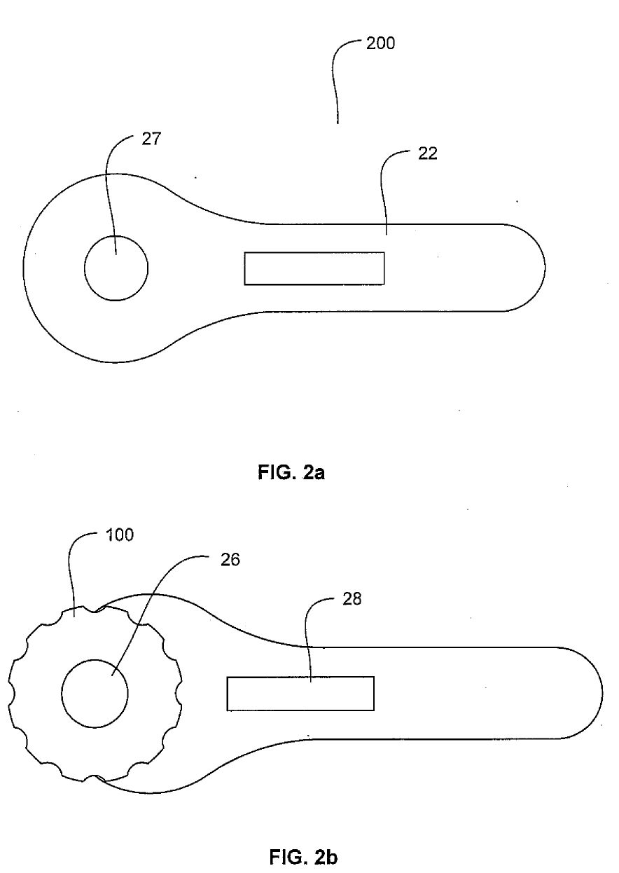

FIG. 2a shows a rotary cutting tool 200 for creating slits in wearable fabric with multiple rotary blades for creating a line of slits through which embellishment can be inserted, having handle 22 and axle 27 around which rotary blade 100 rotates. Alternatively, rotary cutting tool 200 may have a single blade, or may have one or more blades without teeth for separating two pieces of fabric.

FIG. 2b shows a rotary cutting tool which includes a rotary cutting blade 100 mounted within a housing 26 having an axle on which rotary cutting blade 100 rotates. Pressure is applied to housing 28 to move the blade.

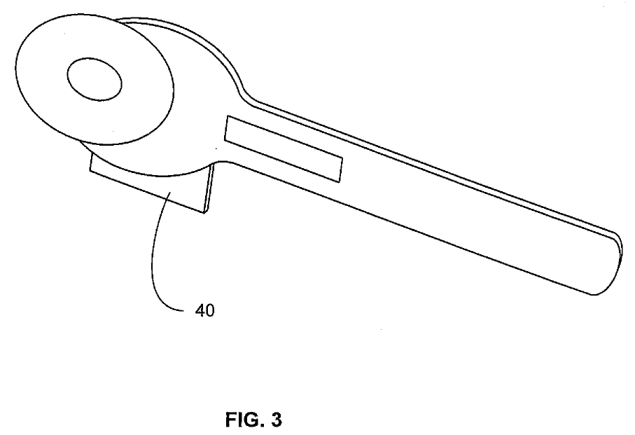

FIG. 3 shows a rotary cutting tool with an edge guide 30 to allow the user to create slits in a straight line

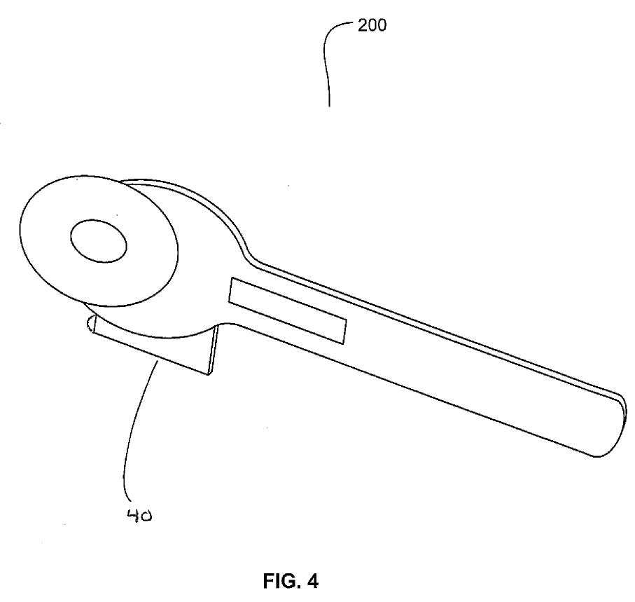

FIG. 4 shows a rotary cutting tool with an edge guide 40 that is a light or laser powered by a small battery within the handle or housing. (not shown)

1. A rotary blade for embellishment of wearable fabric comprising:
a plurality of teeth spaced at a distance from 2/8 to 4/8 of an inch apart,
wherein said distance is calculated so as not to tear wearable fabric; and
an aperture through which an axle is inserted.

2. The rotary blade of claim 1 wherein said rotary blade is adapted to be interchangeable so as to be substituted with the existing rotary blade of rotary cutting tools.

3. The rotary blade of claim 1 wherein said rotary blade is adapted to be interchangeable so as to be substituted with the existing rotary blade of rotary cutting tools said existing rotary cutting tools selected from a group of rotary cutting tools having a handle and an axle for rotating a blade.

4. The rotary blade of claim 1 wherein said rotary blade is adapted to be interchangeable so as to be substituted with the existing rotary blade of rotary cutting tools said existing rotary cutting tools selected from a group of rotary cutting tools having an outer housing and an axle for rotating a blade.

5. The rotary blade of claim 1 wherein said rotary blade is made from a material selected from a group consisting of steel, stainless steel and metal alloys.

6. The rotary blade of claim 1 wherein the wearable fabric is selected from a group consisting of outerwear fleece, Berber, Minky, sweatshirt fleece, stretch velvet, felt, knits leather, faux leather, interlock knits, cottons, double knits, silk, rayon, wool, suede and faux suede.

7. The rotary blade of claim 1 wherein the embellishment is selected from a group consisting of ribbon, cord, thread, string, beaded strings, heavy thread, textured thread, yarn, chenille yarn, metallic yarn, eyelash yarn and fuzzy yarn.

8. The rotary blade of claim 1 wherein said rotary blade is interchangeable with any standard rotary blade used in a rotary cutting tool having, said rotary cutting tool having a handle and an axle.

9. A device for selectively piercing wearable fabric comprising:
At least one interchangeable rotary cutting blade; and
at least one blade having teeth having a distance from 2/8 to 4/8 of an inch apart, wherein said distance is calculated so as not to tear wearable fabric wherein the teeth are shaped to pierce wearable fabric without shredding the fabric.

10. The device of claim 9 wherein said at least one rotary cutting blade is interchangeable.

11. The device of claim 9 wherein said interchangeable rotary cutter is adapted to include more than one said rotary blade, said more than one rotary cutting blades creating parallel slit formations.

12. The device of claim 9 wherein said interchangeable rotary cutter is adapted to include more than one said rotary blade, said more than one rotary cutting blades creating parallel slit formations in a line, each line of said parallel slit formations having slits of varying dimensions.

13. The device of claim 9 which further includes a handle having a protective barrier to prevent a hand from sliding forward.

14. The device of claim 9 wherein said interchangeable rotary cutter is adapted to include a first rotary blade having teeth having a distance from 2/8 to 4/8 of an inch apart adapted to create slits in wearable fabric, and a second rotary cutting blade having no teeth so that that it is adapted to separate two portions of fabric.

15. The device of claim 9 which further includes an edge guide.

16. The device of claim 9 wherein said at least one rotary blade has diameter selected from a group consisting of 28 mm, 45 mm and 60 mm.

17. A device for selectively piercing wearable fabric comprising:
at least one interchangeable rotary blade;
at least one edge guide to identify a straight-line path;
at least one blade having teeth having a distance from 2/8 to 4/8 of an inch apart, wherein said distance is calculated so as not to tear wearable fabric wherein the teeth are shaped to pierce wearable fabric without shredding the fabric.

18. The device of claim 17 wherein said edge guide is a device using a beam of light.

19. The device of claim 17 wherein said edge guide is a device using a laser.

20. The device of claim 17 which further includes a handle having a protective barrier to prevent a hand from sliding forward.
